(19) United States
(12) Patent Application Publication
(10) Pub. No.: US 2026/0369974 A1
(43) Pub. Date: Nov. 19, 2026

(54) PLIERS-TYPE CUTTING TOOL

(71) Applicant: KNIPEX-Werk C. Gustav Putsch KG, Wuppertal (DE)

(72) Inventor: Marcus KREMSER, Wermelskirchen (DE)

(73) Assignee: KNIPEX-Werk C. Gustav Putsch KG, Wuppertal (DE)

(21) Appl. No.: 19/141,097

(22) PCT Filed: Dec. 19, 2023
(86) PCT No.: PCT/EP2023/086614

§ 371 Date: Jun. 19, 2025

(30) Foreign Application Priority Data
Dec. 27, 2022 (DE) 10 2022 134 812.1

(51) Int. Cl. H02G 1/00; H02G 1/12

(52) U.S. Cl. CPC H02G 1/005; H02G 1/1214

(57) ABSTRACT

A pliers-type cutting tool has two pliers legs, which are pivotably connected to one another at a joint and each form a gripping region on one side and a working region on the other side. The working regions have a substantially constant thickness in a longitudinal extent and form a cutting edge and a gripping surface. The cutting edges interact in a cutting plane and the gripping surface is formed further away from the joint than the cutting edges. One pliers leg is formed transverse to the cutting plane to transition into a section forming the gripping surface. The pliers leg in the longitudinal extent, with reference to a plan view in a closed position of the pliers legs where the cutting plane appears as a line, passes through the cutting plane, changing the direction of a central plane of the pliers legs which is linear in the plan view.

### TECHNICAL FIELD

The invention relates to a pliers-type cutting tool with a first and a second pliers leg, which are pivotably connected to one another at a joint and respectively form a gripping region on one side of the joint and a working region on the other side of the joint, wherein the pliers legs have an essentially constant thickness in their longitudinal extent in their part forming the working region, wherein the working regions furthermore form a cutting edge and a gripping surface, wherein the cutting edges furthermore interact in a cutting plane, wherein the gripping surface furthermore is formed farther away from the joint than the cutting edges, wherein one pliers leg furthermore is formed so as to cross the cutting plane in the longitudinal extent in order to transition into a section forming the gripping surface, and wherein the pliers leg furthermore passes through the cutting plane in the longitudinal extent with reference to a plan view in a closed position of the pliers legs, in which plan view the cutting plane appears as a line, while changing the direction of a central plane of the pliers legs, which is linear in the plan view.

### PRIOR ART

Pliers-type cutting tools of the type in question are known. In this context, we refer, for example, to DE 10 2005 008 328 A1. This publication discloses a cutting tool that can be used in the field of electrical installations. Each working region of the cutting tool has a cutting edge, as well as a gripping surface formed in the region of the free ends of the working regions. In order to form the gripping surface, the free ends of the working regions are angled in opposite directions, wherein each pliers leg partially crosses the cutting plane with an end-side working region while the pliers leg thickness is maintained. After this crossing region of the pliers leg, the free end of this pliers leg forming the gripping surface extends in the same direction as the pliers leg in the remaining working region. The length of the gripping surface in the direction of the cutting plane is greater than the respective length or width of the gripping surface resulting transverse thereto.

### SUMMARY OF THE INVENTION

In light of the above-described prior art, the invention aims to advantageously enhance the design of a pliers-type cutting tool of the type in question.

According to a first inventive idea, this objective is potentially attained with a pliers-type cutting tool, in which it is proposed that the length of the gripping surface formed by both pliers legs perpendicular to the cutting plane is greater than the thickness of each pliers leg.

Improved handling of the tool is achieved, for example, in the course of taking hold of and twisting two or more wires due to the fact that the length of the gripping surface viewed perpendicular to the cutting plane is greater than the thickness of the pliers leg viewed in the same direction. The relevant length of the gripping surface may correspond, for example, to 1.2-times the pliers leg thickness or more, e.g. to approximately 1.5-times to 2-times the pliers leg thickness or more, furthermore to approximately 2.1-times to 3-times the pliers leg thickness.

It is also preferred that the depth of the gripping surface resulting in the longitudinal extent corresponds to the thickness of a pliers leg.

The free end section of the pliers leg, which follows in the longitudinal extent of the pliers leg starting from the joint in the direction of the free end and contributes to forming at least part of the gripping surface, preferably is dimensionally adapted to the remaining pliers leg thickness, particularly in the region resulting between the joint and the change in direction, with respect to its thickness, which in this end section preferably results as the depth of the gripping surface referred to the longitudinal extent. This can be advantageously achieved by bending the relevant pliers leg end section, for example, if the pliers leg is realized in the form of a sheet steel stamping.

The central plane that passes through the pliers leg centrally in its thickness may extend parallel to the cutting plane in the remaining working region, e.g. in the region of the cutting edge, and furthermore be aligned essentially in the longitudinal extent of the pliers leg.

The partial sections of the central plane resulting from the change in direction may with reference to the plan view transition into one another in a sharp-edged manner, e.g. with inclusion of a right angle or an acute angle, but this transition region from one partial section of the central plane to a following partial section may also be rounded. Such a rounded transition region furthermore can be achieved, for example, during the formation of the angular offset resulting from the change in direction by bending the pliers leg.

After the change in direction, the central plane or the partial section of the central plane resulting after the angular offset may with reference to the plan view extend along a straight line and/or in a curved manner along a curved line.

A change in direction of the central plane occurs when, with respect to the extending direction of the central plane in the plan view, the end of a uniform extent (for example, a linear and/or at least approximately uniformly curved extent) of a partial section of the central plane is followed by another partial section with a changed extent of the central plane passing through the cutting plane.

Other characteristics frequently are described below, as well as in the description of the figures, in their preferred association with the basically described solution or with additional characteristics. However, they may also be important in association with only individual characteristics described above or with the respective additionally described characteristic or independently.

According to a preferred embodiment, the change in direction may result from a crossing of the pliers leg essentially perpendicular to the cutting plane—with reference to the plan view. The free end section of the pliers leg forming the gripping surface accordingly may essentially extend, for example, approximately perpendicular to the remaining pliers leg after the change in direction—likewise with reference to the plan view in the closed pliers leg position.

It is furthermore preferred that, with reference to the plan view, the pliers legs extend in opposite directions in the region of their free ends after the (first) change in direction such that both pliers legs pass through the cutting plane with an angular offset, for example, about an imaginary axis that appears as a point in the plan view, wherein pliers leg ends forming the gripping surfaces furthermore preferably are, with reference to this plan view, in overlap in their respective longitudinal extent. As a result of the (first) change in direction, the pliers legs preferably cross the cutting plane completely with both longitudinally extending outer edges formed with respect to a thickness Of a pliers leg in the aforementioned plan view.

According to an enhancement, the pliers leg may in the longitudinal extent also pass through the cutting plane with a twofold change in direction, namely a first and a second change in direction. In this case, the respective pliers leg preferably can pass through the cutting plane, namely completely in the aforementioned sense, in the vertical direction with reference to the plan view, but alternatively also with inclusion of an acute angle of, for example, 30 to 60°, e.g. approximately 45°, to the cutting plane in the region of the first change in direction, as well as in the region of the second change in direction. Accordingly, a free end of the pliers leg may with respect to the cutting plane extend on the side, on which the remainder of the relevant pliers leg also extends, e.g. in the region of its cutting edge. As a result of the twofold change in direction, the first pliers leg extends, with reference to the plan view, from one side of the cutting plane toward the other side of the cutting plane, on which the remainder of the second pliers leg extends, i.e. particularly in the region of its cutting edge, and subsequently back to the original side of the cutting plane. This makes it possible to realize comparatively large gripping surfaces that can be brought in overlap with one another.

In another preferred embodiment, a twofold change in direction is provided on both pliers legs, wherein this is accordingly realized with respectively opposite extent with reference to the plan view. The thusly attainable overlapping gripping surface lengths of both pliers legs perpendicular to the cutting plane may correspond to 2-times a pliers leg thickness or more, e.g. to as much as 3-times or 4-times or even 5-times a pliers leg thickness or more.

In another preferred embodiment, the pliers leg as a whole follows the resulting angular offset at each change in direction. The pliers leg as a whole therefore follows the change in direction carried out by the central plane. This preferably can also be the case if only one change in direction takes place. In this case, the pliers leg preferably crosses the cutting plane over its entire width viewed perpendicular to its thickness, preferably while essentially maintaining the pliers leg thickness, which is also consistently constant in the region of the change in direction or changes in direction, respectively.

The pliers legs may delimit a free space resulting in overlap with the cutting plane between the first and the second change in direction. This free space preferably can be formed to both sides of the pivoting plane with reference to the plan view. The pivoting plane passes through the contiguous free space. It is furthermore preferred that such a free space is designed identically to both sides of the pivoting plane. In this respect, the free space has, so to speak, two imaginary halves. Accordingly, a free space extending in the direction of the pliers leg width preferably is formed between the pliers legs. This free space can be used, for example, for taking hold of a wire or the like, as well as for bending a wire inserted through the free space.

Such a free space preferably is completely encompassed by the pliers legs in the plan view. The pliers legs form a completely closed delimitation of the free space with reference to the plan view.

It is also preferred to provide the gripping surface with a toothing. According to a preferred alignment of the toothing, the ridges of the teeth, which extend at a distance from one another transverse to the extending direction of the toothing, are aligned essentially perpendicular to the cutting plane. In this case, the toothed region of each pliers leg furthermore may cross the cutting plane once or multiple times, particularly twice. Accordingly, the toothed region may extend over the region of the one change in direction or both changes in direction, as well as over the free end section of the respective pliers leg.

With respect to the disclosure, the ranges or value ranges or multiple ranges indicated above and below also include all intermediate values, particularly in 1/10 increments of the respective dimension, but optionally also dimensionless. For example, the indication 1.2-times to 2-times also includes the disclosure of 1.3-times to 2-times, 1.2-times to 1.9-times, 1.3-times to 1.9-times, etc., and the indication 30 to 60° also includes the disclosure of 30.1 to 60°, 30 to 59.90, 30.1 to 59.9° etc. The respective disclosure may on the one hand serve for defining a lower and/or upper limit of a cited range, but alternatively or additionally also for disclosing one or more singular values from a respectively indicated range.

### BRIEF DESCRIPTION OF THE DRAWINGS

The invention is described in greater detail below with reference to the attached drawings that, however, merely show exemplary embodiments. A component, which is described with reference to one of the exemplary embodiments and not replaced with a different component in another exemplary embodiment, is therefore also described as a potentially existing component in this other exemplary embodiment. In the respective drawings:

FIG. 1 shows a perspective view of a cutting tool of the type in question concerning a first embodiment;

FIG. 2 shows an exploded perspective view of the cutting tool according to FIG. 1;

FIG. 3 shows the view of the cutting tool according to the arrow III in FIG. 1 concerning a closed pliers leg position;

FIG. 4 shows a view corresponding to FIG. 3 and concerning an open pliers leg position;

FIG. 5 shows the plan view of the cutting tool according to the arrow V in FIG. 1;

FIG. 6 shows the side view of the cutting tool according to the arrow VI in FIG. 1;

FIG. 7 shows a detailed perspective view of the working region of the pliers legs concerning the closed pliers leg position;

FIG. 8 shows the enlargement of the region VIII in FIG. 7;

FIG. 9 shows the enlargement of the region IX in FIG. 5;

FIG. 10 shows the enlargement of the region X in FIG. 3;

FIG. 11 shows the enlargement of the region XI in FIG. 6;

FIG. 12 shows an exploded perspective detail of two pliers legs according to a second embodiment;

FIG. 13 shows an enlarged detail essentially corresponding to FIG. 8 and concerning the second embodiment; and

FIG. 14 shows an enlarged detail according to FIG. 9 concerning the embodiment according to FIG. 12.

### DESCRIPTION OF THE EMBODIMENTS

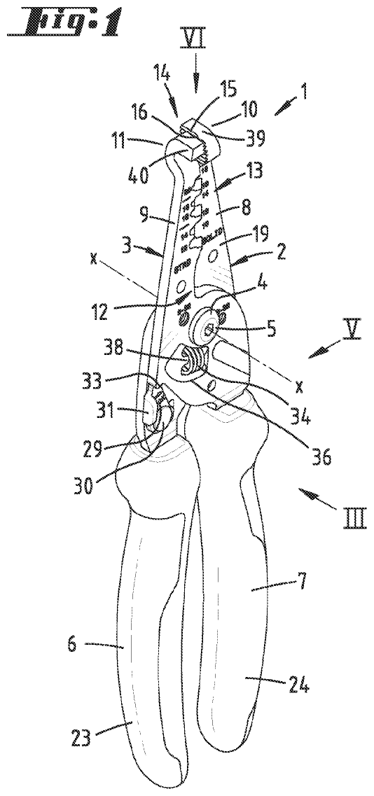

A pliers-type cutting tool 1 with a first pliers leg 2 and a second pliers leg 3 is initially described with reference to the illustration in FIG. 1.

The two pliers legs 2 and 3 are connected to one another so as to be pivotable about a geometric pivoting axis x at a joint 5 that is formed by a joint pin 4. Starting from the joint 5, the pliers legs 2, 3 respectively form gripping regions 6 and 7 on one side of the joint 5 and working regions 8 and 9 on the other side of the joint 5 along their respective longitudinal extent L.

The gripping regions 6, 7 and the working regions 8, 9 of the pliers legs 2 and 3 are realized integrally and preferably uniformly in material, preferably based on sheet steel stampings. It is furthermore preferred that each working region 8, 9 has a consistently constant thickness d viewed in the direction of the pivoting axis x, wherein said thickness preferably is also realized consistently in the respective gripping regions 6 and 7 and preferably corresponds to the thickness d of a working region. The entire pliers legs 2, 3 may be respectively formed based on a uniform stamping.

Viewed from the joint 5 in the direction of a free end 10, 11 of the working regions 8 and 9, the cutting tool 1 initially has a first cutting region 12, which preferably is followed by a second cutting region 13, wherein said first and/or second cutting region 12, 13 is followed by a gripping region with the gripping surfaces 15 and 16, which gripping region forms a terminal flat jaw region on the ends of the working regions 8 and 9.

The first cutting region 12 is formed by cutting edges 17, 18 of the pliers legs 2 and 3. It is furthermore preferred that this first cutting region 12 is realized in the form of a side cutter, e.g. for cutting wires or the like.

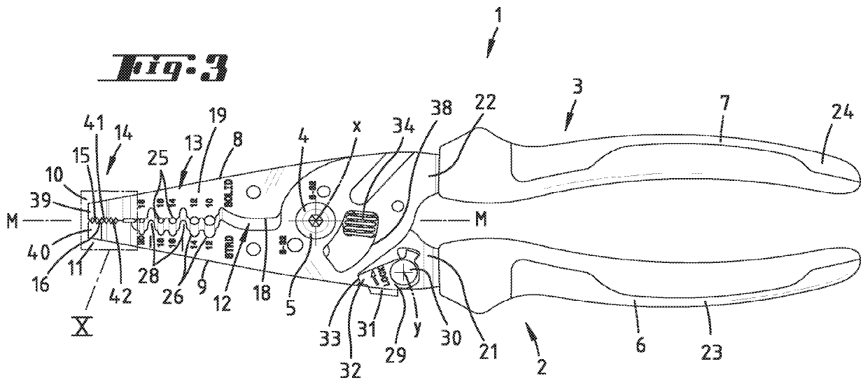

The cutting edges 17 and 18 interact in a cutting plane E that extends perpendicular to the pivoting axis x. In this cutting plane E, the facing plane inner surfaces 19 and 20 of the working regions 8 and 9 essentially may come in contact with one another at least in the cutting regions 12 and 13 such that the cutting edges 17 and 18 can slide past one another from an open pliers leg position according to the illustration in FIG. 4 into a closed pliers leg position according to FIG. 3 like scissors during a pivoting movement of the pliers legs 2 and 3.

Cranked portions 21 and 22 in the direction of the cutting plane E may be provided in the transition from a working region into a gripping region and optionally pass through said cutting plane at least partially. The respective gripping region extends in a freely tapered manner after this cranked portion. Each gripping region 6 and 7 preferably is provided with a gripping sleeve 23, 24.

The second cutting region 13 preferably is realized in the form of a wire stripping region that preferably comprises multiple cutting formations, wherein said cutting formations optionally are respectively formed by two interacting first blade edges 25 and second blade edges 26 that accordingly are arranged opposite of one another on the first pliers leg 2 and the second pliers leg 3. In order to optically and haptically partition the cutting formations and to also allow fast and intuitive locating of the relevant cutting formation for the wire to be stripped under inferior lighting conditions, separating webs 27, 28 are provided, for example, on the first pliers leg 2 and on the second pliers leg 3 and divide the cutting formations into three groups that respectively comprise two cutting formations or one cutting formation. In the closed pliers position according to FIG. 3, the separating webs 27 and 28 pass over a central plane M, which is oriented perpendicular to the cutting plane E and includes the pivoting axis x, and contact the facing plane inner surface 19 or 20 of the other pliers leg.

Furthermore, the closed pliers leg position according to FIG. 3 preferably can also be a cutting tool securing position, in which the pliers legs are locked relative to one another. A latch 29 that is pivotable about a geometric axis y extending parallel to the pivoting axis x is provided for this purpose. This latch is pivotably mounted on a pin 30 that is arranged, for example, on the first pliers leg 2. An operating handle 31 that protrudes in a tab-like manner makes it possible to pivot the latch 29 from a locking position into a release position and back into the locking position, wherein a latch projection 32 is in the locking position moved against a correspondingly positioned and designed locking shoulder 33 of the other pliers leg, in this case the second pliers leg 3 (see also FIG. 3).

Furthermore, the pliers legs 2 and 3 can be displaced from the open pliers leg position according to FIG. 4 in the direction of the closed pliers leg position, which is illustrated as an example in FIG. 3, against a spring force. A cylindrical pressure spring 34 may be provided for this purpose as shown, wherein this cylindrical pressure spring lies in window-like recesses 35 and 36 of the pliers legs 2 and 3, which recesses can be brought in overlap in the direction of the pivoting axis x. The respective ends of the pressure spring 34 are secured on a projection 37, 38 of the respective pliers leg 2 or 3, which projection protrudes into the respective recess 35 or 36, as a result of encompassing the projection.

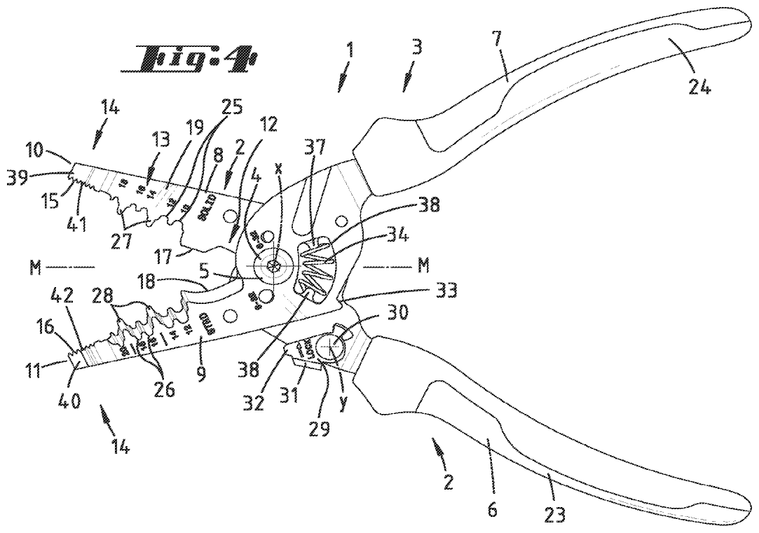

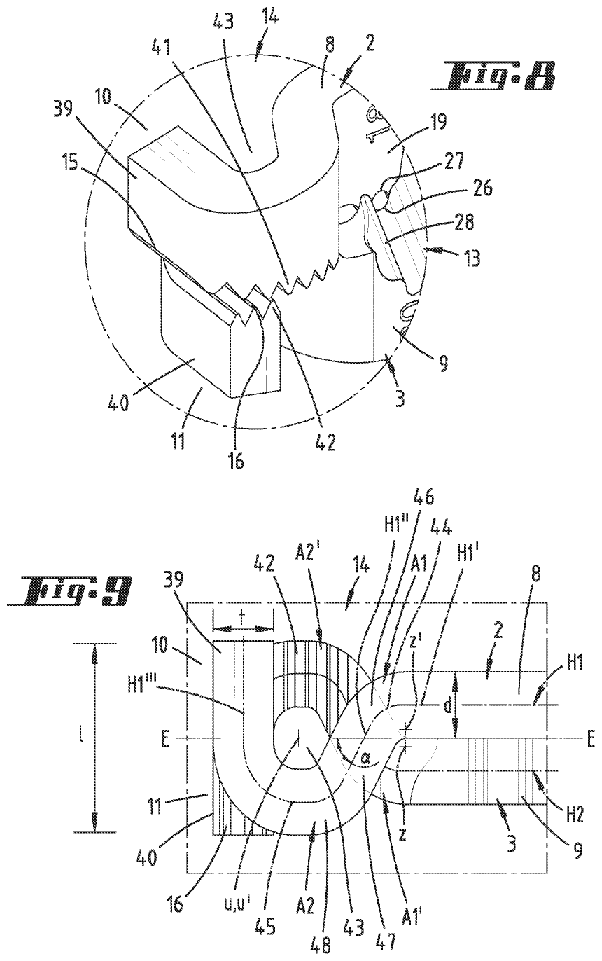

In order to form the gripping region 14, each pliers leg 2, 3 is in the region of its free end 10, 11 designed for preferably crossing the cutting plane E completely, wherein, with reference to a plan view in the closed position of the cutting tool 1 according to the illustration in FIG. 5, in which the cutting plane E appears as a line, the pliers legs 2 and 3 pass through the cutting plane E while a change in direction of a central plane H1 of the pliers leg 2 and a central plane H2 of the pliers leg 3, which in this plan view respectively appear as a line, takes place (see also FIG. 9).

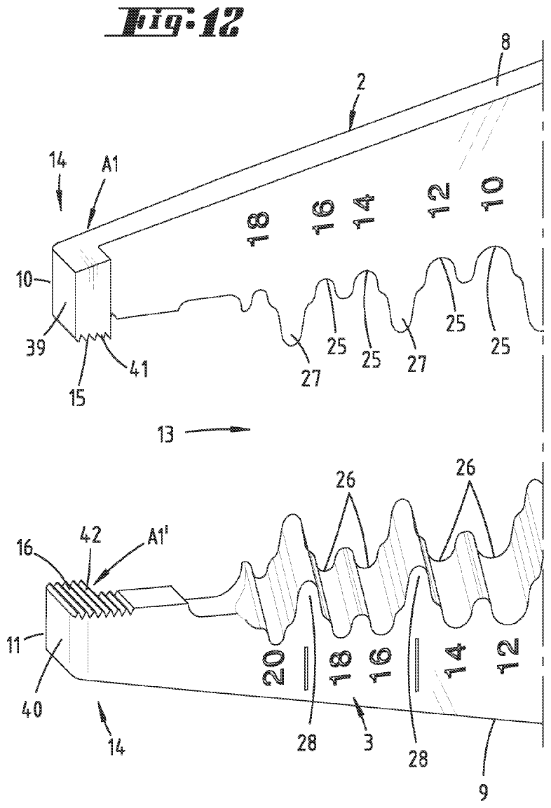

If only one angular offset is formed due to a change in direction on each pliers leg 2 and 3 (first change in direction A1 the first pliers leg 2 and first change in direction A1′ of the second pliers leg 3) as illustrated in the second embodiment according to FIGS. 12 to 14, for example, a right-angled change in direction of the extent of the respective central plane H1 or H2 may be formed with reference to the plan view.

In this case, a first partial central plane section H1′ of the pliers leg 2 essentially extends parallel to the cutting plane E centrally of the pliers leg thickness d in the cutting regions 12 and 13. After a transition 44 of the central plane H1, which in the exemplary embodiment is at least approximately angular, a second partial central plane section H1″ follows in the region of the end section 39, wherein said second partial central plane section preferably includes a right angle with the first partial central plane section H1″ with reference to the plan view. Accordingly, a passage angle a of 90° preferably is formed between this partial section H1″ or the central plane H1 as a whole and the cutting plane E. The central plane H2 of the pliers leg 3 extends equivalently and, with reference to the line-shaped cutting plane E in the plan view, in the form of a mirror image of the extent of the central plane H1 of the pliers leg 2.

The facing gripping surfaces 15 and 16 formed in the respective angled end sections 39 and 40 may be arranged in complete overlap in a vertical projection on the plan view as illustrated in FIG. 14. Viewed perpendicular to the pivoting plane E, this results in a length 1 of the gripping surfaces 15 and 16, particularly of the overlapping sections of the gripping surfaces 15 and 16 if they are not in complete overlap, wherein the length 1 may approximately correspond to 2-times the thickness d of the respective pliers leg 2 or 3 in the exemplary embodiment illustrated in FIG. 14.

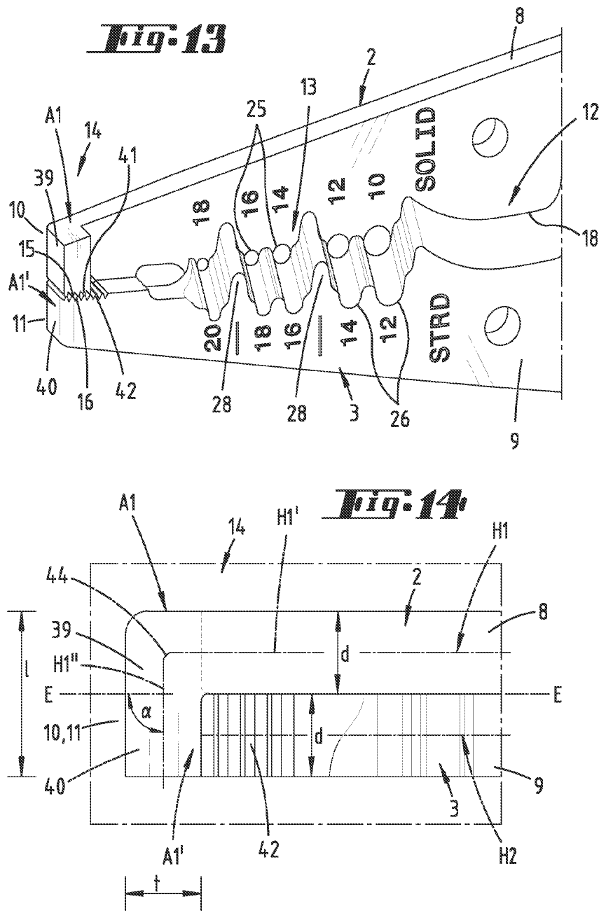

The gripping surfaces 15 and 16 preferably are provided with a toothing 41, 42, wherein the respective toothing preferably is aligned perpendicular to the alignment of the cutting plane E. For example, FIG. 13 shows that the respective toothing 41, 42 may, if applicable, extend beyond the gripping surface 15, 16 in the direction and as far as the beginning of the optional second cutting region 13.

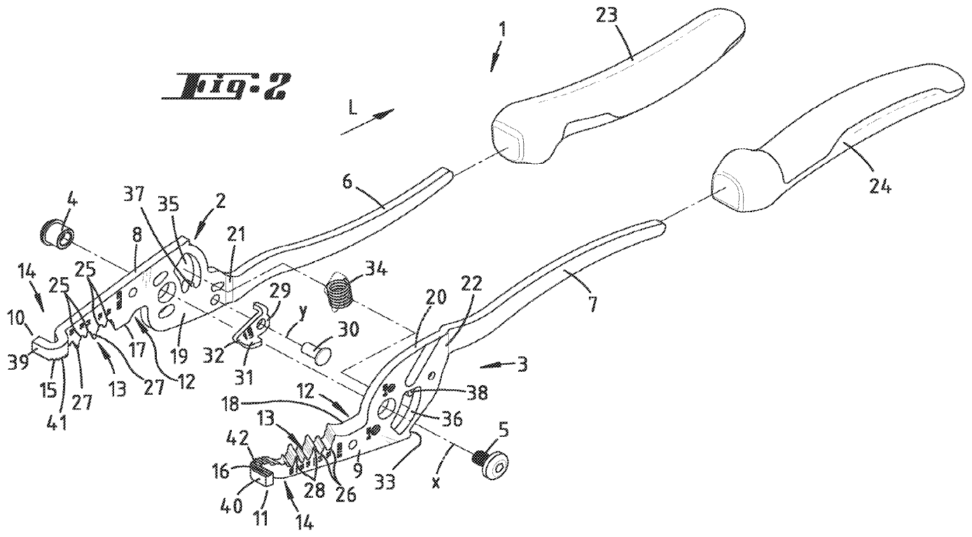

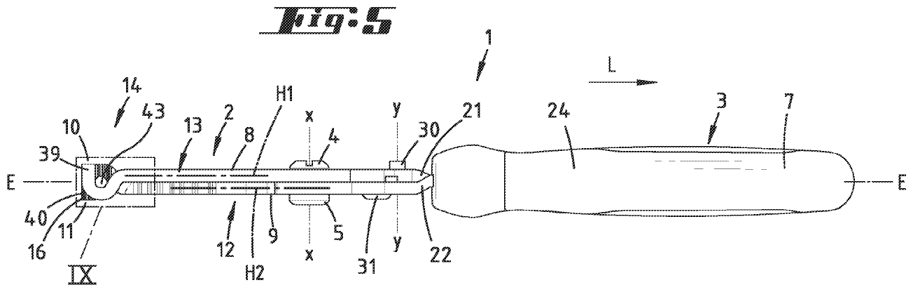

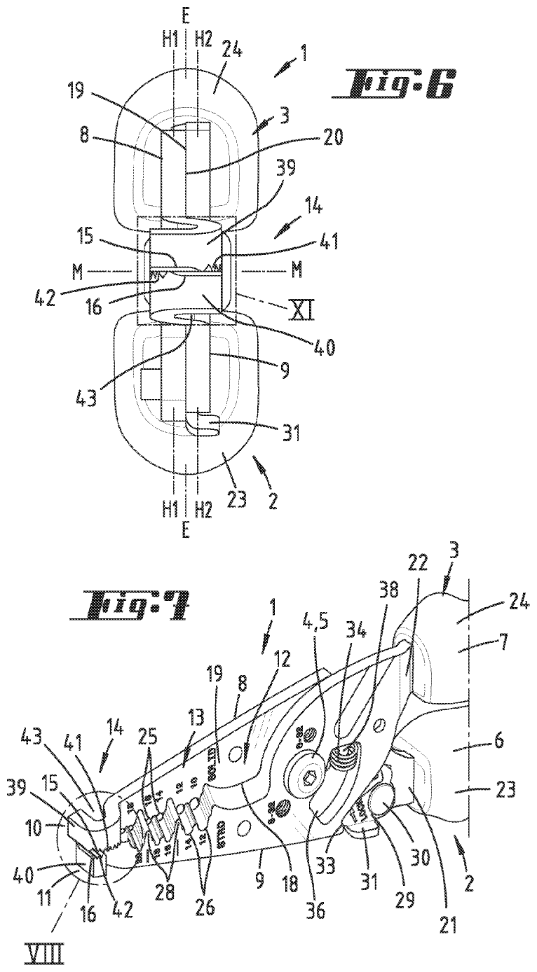

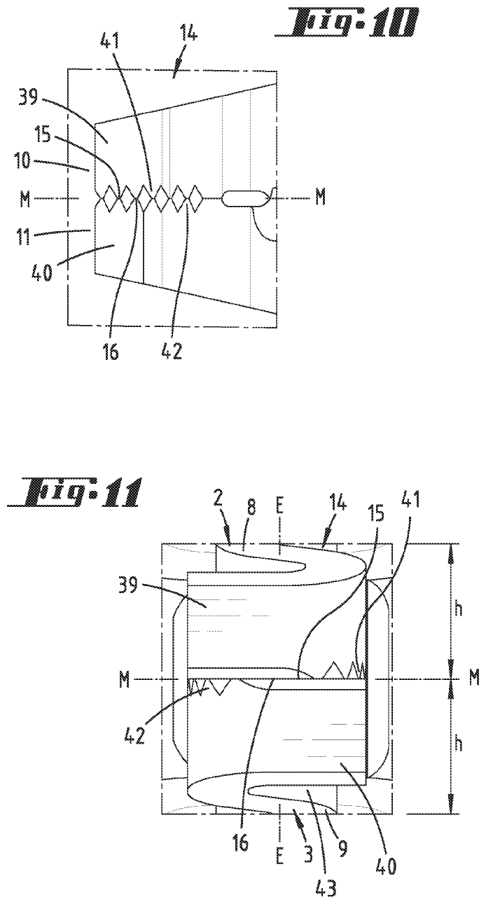

The exemplary embodiment illustrated in FIGS. 1 to 11 is provided with two successive changes in direction of the respective central planes H1 and H2 in order to form the gripping region 14. A first change in direction Al and Al′ initially is provided following the second cutting region 13, particularly with reference to the detail illustrated in FIG. 9. In this case, the pliers legs 2 and 3 respectively cross the cutting plane E completely, wherein the pliers legs 2 and 3 intersect one another with reference to the plan view according to FIG. 9 in a projection viewed perpendicular thereto.

In contrast to the embodiment according to FIG. 14, a twofold change in direction of the central planes H1 and H2 may optionally not involve a perpendicular passage through the cutting plane E in the region of the first change in direction. In fact, a passage through the cutting plane E at an acute angle a of, for example, approximately 30 to 45° may also be realized as shown.

In this context, it is essential that the respective pliers leg passes through the cutting plane E completely over the entire height h of the respective pliers legs 2 and 3 viewed perpendicular to the central plane M.

A second change in direction A2 and A2′ of the respective central planes H1 and H2 follows the first change in direction A1 and A1′. As a result of this second change in direction, the end sections 39 and 40 of the respective pliers legs 2 and 3 preferably are aligned perpendicular to the cutting plane E and, passing through this cutting plane, returned to the side of the cutting plane E, on which the remainder of the relevant pliers leg extends. The pliers leg accordingly is realized in a hook-shaped manner facing the relevant free end such that it completely passes through the cutting plane E twice.

In this embodiment, a rounded transition 44 is formed at the first change in direction Al of the pliers leg 2 between the first partial central plane section H1′ of the pliers leg 2, which preferably extends essentially parallel to the cutting plane E, and the following second partial central plane section H1″ passing through the cutting plane E, wherein said rounded transition is formed, for example, by an angular offset of the relevant pliers leg region as a result of a bend about an imaginary geometric axis z (or z′ with respect to the pliers leg 3), which extends in the direction of the height of the pliers leg and appears as a point in the plan view. Such a bend results in a first curvature section 46 of the second pliers leg 2, which first curvature section may be followed by a straight section 47 that passes through the cutting plane E at the above-described acute angle a of, for example, 45° as shown.

The second change in direction A2 of the same pliers leg 2 may also be realized by an angular offset of the relevant pliers leg region as a result of a bend about another imaginary geometric axis u (or u′ with respect to the pliers leg 3) extending parallel to the imaginary axis z as shown. This bend results in a second curvature section 48 that follows the straight section 47 and may extend, for example, over an angle of approximately 135° such that it preferably is altogether oriented back in the direction of the cutting plane E. Accordingly, a curved transition 45 of the central plane H1 between the second partial central plane section H1″ and the terminal third partial central plane section H1″′ of the linearly extending end section 39, which follows this second curvature section 48, is also formed at the second change in direction A2, wherein said third partial central plane section H1″′ preferably is aligned at an angle of 90° to the cutting plane E with reference to the plan view.

In this embodiment, the central plane H2 of the pliers leg 3 also extends equivalently and, with reference to the line-shaped cutting plane E in the plan view, in the form of a mirror image of the extent of the central plane H1 of the pliers leg 2, wherein curved curvature sections, between which a straight section passing through the cutting plane E is arranged, are likewise formed.

The illustration in FIG. 9, in particular, furthermore shows that the imaginary axes u and u′ of the second curvature sections essentially may coincide in the region of the second changes in direction A2 and A2′ of the central planes H1 and H2 and furthermore essentially extend in the cutting plane E with reference to the closed position of the pliers legs. The pliers legs 2 and 3 furthermore may delimit a free space 43 resulting in overlap with the cutting plane E between the respective first and second changes in direction essentially in the region of the second curvature section and preferably completely encompass the free space. This free space 43 preferably can extend approximately concentric to the respective imaginary axes u and u'.

The length 1 of the gripping surfaces 15 and 16, which are formed in the end sections 39 and 40 and essentially overlap in the vertical projection, may approximately correspond to 2.5-times to 3-times the pliers leg thickness d. In the region of the angled end sections 39 and 40, the depth t of the respective gripping surface 15 or 16 viewed in the longitudinal extent L of the pliers legs 2 and 3 corresponds to the thickness d of the respective pliers leg 2 or 3.

The preceding explanations serve for elucidating all inventions that are included in this application and respectively enhance the prior art independently with at least the following combinations of characteristics, wherein two, multiple or all of these combinations of characteristics may also be combined with one another, namely:

A cutting tool, which is characterized in that the length 1 of the gripping surface 15, 16 formed by both pliers legs 2, 3 perpendicular to the cutting plane E is greater than the thickness d of each pliers leg 2, 3, and in that the depth t of the gripping surface 15, 16 viewed in the longitudinal extent L corresponds to the thickness d of a pliers leg 2, 3.

A cutting tool, which is characterized in that the pliers leg 2, 3 passes through the cutting plane E in the longitudinal extent L with a twofold change in direction, namely a first change in direction Al, Al′ and a second change in direction A2, A2′ of the central plane H1, H2.

A cutting tool, which is characterized in that the pliers leg 2, 3 as a whole follows the change in direction A1, A1′, A2, A2′ of the central plane H1, H2 at each change in direction A1, A1′, A2, A2′.

A cutting tool, which is characterized in that the pliers legs 2, 3 delimit a free space 43 formed in overlap with the cutting plane E between the first change in direction A1, Al′ and the second change in direction A2, A2′.

A cutting tool, which is characterized in that the free space 43 is completely encompassed by the pliers legs 2, 3 in the plan view.

A cutting tool, which is characterized in that the gripping surface 15, 16 is provided with a toothing 41, 42.

All disclosed characteristics are essential to the invention (individually, but also in combination with one another). The disclosure of the associated/attached priority documents (copy of the priority application) is hereby fully incorporated into the disclosure content of this application, namely also for the purpose of integrating characteristics of these documents into claims of the present application. The characteristics of the dependent claims also characterize independent inventive enhancements of the prior art without the characteristics of a claim to which they refer, particularly for submitting divisional applications on the basis of these claims. The invention specified in each claim may additionally comprise one or more of the characteristics that were disclosed in the preceding description and, in particular, are identified by reference symbols and/or included in the list of reference symbols. The invention also concerns design variations, in which individual characteristics cited in the preceding description are not realized, particularly as far as they are obviously dispensable for the respective intended use or can be replaced with other, identically acting technical means.

### LIST OF REFERENCE SYMBOLS

1 Cutting tool
2 First pliers leg
3 Second pliers leg
4 Joint pin
5 Joint
6 Gripping region
7 Gripping region
8 Working region
9 Working region
10 Free end
11 Free end
12 First cutting region
13 Second cutting region
14 Gripping region
15 Gripping surface
16 Gripping surface
17 Cutting edge
18 Cutting edge
19 Inner surface
20 Inner surface
21 Cranked portion
22 Cranked portion
23 Gripping sleeve
24 Gripping sleeve
25 Blade edge
26 Blade edge
27 Separating web
28 Separating web
29 Latch
30 Pin
31 Operating handle
32 Latch projection
33 Locking shoulder
34 Cylindrical pressure spring
35 Recess
36 Recess
37 Projection
38 Projection
39 End section
40 End section
41 Toothing
42 Toothing
43 Free space
44 Transition
45 Transition
46 First curvature section
47 Straight section
48 Second curvature section
d Thickness
h Height
l Length
t Depth
u Axis
u′ Axis
X Pivoting axis
y Axis
Z Axis
Z′ Axis
A1 First change in direction
A1′ First change in direction
A2 Second change in direction
A2′ Second change in direction
E Cutting plane
H1 Central plane
H2 Central plane
H1′ Partial central plane section
H1″ Partial central plane section
H1″′ Partial central plane section
L Longitudinal extent
M Central plane
α Angle

1. A pliers-type cutting tool (1) comprising a first pliers leg (2) and a second pliers leg (3), which are pivotably connected to one another at a joint (5) and each form a gripping region (6, 7) on one side of the joint (5) and a working region (8, 9) on the other side of the joint (5), wherein the pliers legs (2, 3) have an essentially constant thickness (d) in a longitudinal extent (L) in a part forming the working region (8, 9), wherein each one of the working regions (8, 9) form a cutting edge (17, 18) and a gripping surface (15, 16), the cutting edges (17, 18) interact in a cutting plane (E), the gripping surfaces (15, 16) are formed farther away from the joint (5) than the cutting edges (17, 18) and one of the pliers legs (2, 3) is formed so as to cross the cutting plane (E) in the longitudinal extent (L) in order to transition into a section forming the respective gripping surface (15, 16), and wherein the one pliers leg (2, 3) furthermore passes through the cutting plane (E) in the longitudinal extent (L) with reference to a plan view in a closed position of the pliers legs (2, 3), in which plan view the cutting plane (E) appears as a line, while changing a direction of a central plane (H1, H2) of the pliers legs (2, 3), which is linear in the plan view, wherein the length (l) of the gripping surfaces (15, 16) formed by both pliers legs (2, 3) perpendicular to the cutting plane (E) is greater than the thickness (d) of each pliers leg (2, 3).

2. The cutting tool according to claim 1, wherein a depth (t) of one of the gripping surfaces (15, 16) viewed in the longitudinal extent (L) corresponds to a thickness (d) of the associated pliers leg (2, 3).

3. The cutting tool according to claim 1, wherein the one pliers leg (2, 3) passes through the cutting plane (E) in the longitudinal extent (L) with a twofold change in direction, namely a first change in direction (A1, A1′) and a second change in direction (A2, A2′).

4. The cutting tool according to claim 3, wherein the one pliers leg (2, 3) as a whole follows a resulting angular offset at each change in direction (A1, A1′, A2, A2′).

5. The cutting tool according to claim 3, wherein the pliers legs (2, 3) delimit a free space (43), through which the cutting plane (E) passes, between the first change in direction (A1, A1′) and the second change in direction (A2, A2′).

6. The cutting tool according to claim 5, wherein the free space (43) is completely encompassed by the pliers legs (2, 3) in the plan view.

7. The cutting tool according to claim 1, wherein the gripping surface (15, 16) of the one pliers leg is provided with a toothing (41, 42).

8. The cutting tool according to claim 1, wherein both pliers legs (2, 3) are formed so as to cross the cutting plane (E) in the longitudinal extent (L) in order to transition into a section forming the gripping surface (15, 16), and wherein the pliers legs (2, 3) furthermore pass through the cutting plane (E) in the longitudinal extent (L) with reference to a plan view in a closed position of the pliers legs (2, 3), in which plan view the cutting plane (E) appears as a line, while changing the direction of a central plane (H1, H2) of each of the pliers legs (2, 3), which is linear in the plan view.

9. The cutting tool according to claim 8, wherein the gripping surface of each of the pliers legs viewed in the longitudinal extent (L) has a depth (t) that corresponds to a thickness (d) of the respective pliers leg (2, 3).

10. The cutting tool according to claim 8, wherein both pliers les (2, 3) pass through the cutting plane (E) in the longitudinal extent (L) with a twofold change in direction, namely a first change in direction (A1, A1′) and a second change in direction (A2, A2′).

11. The cutting tool according to claim 8 wherein both pliers legs (2, 3) as a whole follow a resulting angular offset at each change in direction (A1, A1′, A2, A2′).

12. : The cutting tool according to claim 8, wherein both of the gripping surface (15, 16) are provided with a toothing (41, 42).
